(19) United States
(12) Patent Application Publication
(10) Pub. No.: US 2023/0036702 A1
(43) Pub. Date: Feb. 2, 2023

(54) FEDERATED MIXTURE MODELS

(71) Applicant: Qualcomm Technologies, Inc., San Diego, CA (US)

(72) Inventors: Matthias REISSER, Weesp, NH (NL); Max WELLING, Bussum (NL); Efstratios GAVVES, Amsterdam (NL); Christos LOUIZOS, Amsterdam (NL)

(21) Appl. No.: 17/756,957

(22) PCT Filed: Dec. 14, 2020
(86) PCT No.: PCT/US2020/064889

§ 371 Date: Jun. 6, 2022

(30) Foreign Application Priority Data
Dec. 13, 2019 (GR) 20190100556

(51) Int. Cl. G06N 3/02

(52) U.S. Cl. CPC G06N 3/02

(57) ABSTRACT

Aspects described herein provide a method of processing data, including: receiving a set of global parameters for a plurality of machine learning models; processing data stored locally on an processing device with the plurality of machine learning models according to the set of global parameters to generate a machine learning model output; receiving, at the processing device, user feedback regarding machine learning model output for the plurality of machine learning models; performing an optimization of the plurality of machine learning models based on the machine learning output and the user feedback to generate locally updated machine learning model parameters; sending the locally updated machine learning model parameters to a remote processing device; and receiving a set of globally updated machine learning model parameters for the plurality of machine learning models.

### CROSS-REFERENCE TO RELATED APPLICATIONS

This application claims the benefit of and priority to Greek Provisional Patent Application No. 20190100556, filed on Dec. 13, 2019, the entire contents of which are incorporated herein by reference.

### INTRODUCTION

Aspects of the present disclosure relate to machine learning models, and in particular to federated mixture models.

Machine learning may produce a trained model (e.g., an artificial neural network, a tree, or other structures), which represents a generalized fit to a set of training data that is known a priori. Applying the trained model to new data produces inferences, which may be used to gain insights into the new data. In some cases, applying the model to the new data is described as “running an inference” on the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically detecting features (e.g., faces) within images.

Conventional machine learning is often performed in a centralized fashion, such as where training data is collected into a centralized repository and processed collectively to train a machine learning model. Doing so simplifies certain aspects of machine learning. For example, having a unified training data set allows for processing the data according to the independent and identically distributed (IID) assumption for variables in the training data set, which implies that all training data instances (e.g., observations) drawn from the training data set stem from the same generative process, which has no memory of past generated samples. This assumption thus allows the training data to more easily be split into training data subsets and validation data subsets because both subsets are assumed to be identically distributed. Further, this assumption underlies the standard maximum likelihood optimization objective.

Modern electronic devices, especially decentralized portable electronic devices, Internet of Things (IoT) devices, always-on (AON) devices, and other “edge” devices, are increasingly capable of performing machine learning tasks. Thus it is appealing to leverage these device as machine learning compute resources. However, in many contexts, it may not be possible or practical, to generate a globally applicable machine learning model using a decentralized processing approach. For example, physical limitations, such as processing speed, network speed, battery life, and the like, as well policy limitations, such as privacy laws, security requirements, and the like, may limit the ability to decentralize training of machine learning models using a wider variety of compute resources.

Federated learning, which distributes machine learning-related processing to devices at “the edge” (such as the aforementioned portable electronic devices), seeks to overcome some of the aforementioned decentralized processing issues. Unfortunately, the decentralization of data processing explicitly breaks with the standard IID assumption that underlies the standard maximum likelihood optimization objective of various machine learning techniques. Consequently, federated learning may cause current machine learning techniques to degrade in their performance.

Accordingly, what are needed are improved methods for performing federated learning without undermining the efficacy of existing machine learning techniques.

### BRIEF SUMMARY

In a first aspect, a method of processing data, includes: receiving, at an processing device s, a set of global parameters wₖ^{t} for each machine learning model k of a plurality of machine learning models K; for each respective machine learning model k of the plurality of machine learning models K: processing, at the processing device, data stored locally on the processing device with respective machine learning model k according to the set of global parameters wₖ^{t} to generate a machine learning model output y_{s,k}; receiving, at the processing device, user feedback regarding machine learning model output y_{s,k}; performing, at the processing device, an optimization of the respective machine learning model k based on the machine learning output y_{s,k} and the user feedback associated with machine learning model output y_{s,k} to generate locally updated machine learning model parameters wₛ₊ₖ^{t+τ}; and sending the locally updated machine learning model parameters wₛ^{t+τ} to a remote processing device; receiving, from the remote processing device, a set of globally updated machine learning model parameters wₖ^{t+τ} for each machine learning model k of the plurality of machine learning models K, wherein the globally updated machine learning model parameters wₖ^{t+τ} for each respective machine learning model k are based at least in part on the locally updated machine learning model parameters w_{s,k}^{t+τ}.

In a second aspect, a method of processing data, includes: for each respective model k of a plurality of models K: for each respective remote processing device s of a plurality of remote processing devices S: sending, from a server to the respective remote processing device s, an initial set of model parameters wₖ^{t} for the respective machine learning model k; and receiving, at the server from the respective remote processing device s, an updated set of model parameters w_{s,k}^{T+τ} for the respective machine learning model k; and performing, at the server, an optimization of the respective machine learning model k based on the updated set of model parameters w_{s,k}^{T+τ} received from each remote processing device s of the plurality of remote processing devices S to generate an updated set of global model parameters wₖ^{t+τ}; and sending, from the server to each remote processing devices of the plurality of remote processing devices S, the updated set of global model parameters wₖ^{t+τ} for each machine learning model k of the plurality of models K.

Further aspects relate to apparatuses configured to perform the methods described herein as well as non-transitory computer-readable mediums comprising computer-executable instructions that, when executed by a processor of a device, cause the device to perform the methods described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example machine learning model architecture.

FIG. 2 depicts an example of a federated mixture algorithm based on the above derived equations.

FIG. 3 depicts an example method of processing federated mixture model data on a device.

FIG. 4 depicts an example method of processing federated mixture model data on a centralized device, such as a server device.

FIG. 5 illustrates an example electronic device that may be configured to perform the methods described herein.

FIG. 6 depicts an example multi-processor processing system, which may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for improving federated machine learning performance based on using multiple model instances (or “experts”) to perform the maximum likelihood optimization, thus mitigating the impact of training data that do not comport with an independent and identically distributed (IID) assumption. Beneficially, the federated mixture model methods described herein can be performed synchronously or asynchronously across federated devices. Thus, these federated mixture model methods be particularly useful for utilizing low-power processing systems, such as mobile, IoT, edge, and other processing devices having processing, power, data connection, and/or memory size limitations, for federated learning.

### Brief Background on Neural Networks, Deep Neural Networks, and Deep Learning

Neural networks are organized into layers of interconnected nodes. Generally, a node (or neuron) is where computation happens. For example, a node may combine input data with a set of weights (or coefficients) that either amplifies or dampens the input data. The amplification or dampening of the input signals may thus be considered an assignment of relative significances to various inputs with regard to a task the network is trying to learn. Generally, input-weight products are summed (or accumulated) and then the sum is passed through a node's activation function to determine whether and to what extent that signal should progress further through the network.

In a most basic implementation, a neural network may have an input layer, a hidden layer, and an output layer. “Deep” neural networks generally have more than one hidden layer.

Deep learning is a method of training deep neural networks. Generally, deep learning maps inputs to the network to outputs from the network and is thus sometimes referred to as a “universal approximator” because it can learn to approximate an unknown function ƒ(x)=y between any input x and any output y. In other words, deep learning finds the right ƒ to transform x into y.

More particularly, deep learning trains each layer of nodes based on a distinct set of features, which is the output from the previous layer. Thus, with each successive layer of a deep neural network, features may become more complex. Deep learning is thus powerful because it can progressively extract higher level features from input data and perform complex tasks, such as object recognition, by building up a useful feature representation of the input data through multiple layers and levels of abstraction.

For example, if presented with visual data, a first layer of a deep neural network may learn to recognize relatively simple features, such as edges, in the input data. In another example, if presented with audio data, the first layer of a deep neural network may learn to recognize spectral power in specific frequencies in the input data. The second layer of the deep neural network may then learn to recognize combinations of features, such as simple shapes for visual data or combinations of sounds for audio data, based on the output of the first layer. Higher layers may then learn to recognize complex shapes in visual data or words in audio data. Still higher layers may learn to recognize common visual objects or spoken phrases. Thus, deep learning architectures may perform especially well when applied to problems that have a natural hierarchical structure.

### Machine Learning Model Maximum Likelihood Optimization

Machine learning models come in many forms, such as neural networks (e.g., deep neural networks and convolutional neural networks), regressions (e.g., logistic or linear), decision trees (including random forests of trees), support vector machines, cascading classifiers, and others. While neural networks are discussed throughout as one example application for the methods described herein, these same methods may likewise be applied to other types of machine learning models.

In machine learning, the training of a model may be considered as an optimization process by taking a set of observations and performing maximum likelihood estimations such that a target probability is maximized. In statistics, maximum likelihood estimation is a method of estimating the parameters of a probability distribution by maximizing a likelihood function, so that under the assumed statistical model the observed data is most probable. Thus, in the context of a machine learning model, the following expressions may be derived:

$${\hat{θ}}_{ML}$$

$$= g ( {x}^{1} , … , {x}^{M} )$$

$$= {arg max}_{θ} {p}_{model} ( X ; θ )$$

$$= {arg max}_{θ} {\prod }_{i = 1}^{M} {p}_{model} ( {x}^{i} ; θ )$$

$$= {arg max}_{θ} {\sum }_{i = 1}^{M} log {p}_{model} ( {x}^{i} ; θ )$$

$$= {arg max}_{θ} {E}_{x \sim {\hat{p}}_{data}} log {p}_{model} ( x ; θ )$$

In the preceding expressions, \hat{θ}_{ML} is the maximum-likelihood estimator, x¹, . . . , x^{M} are M observations, g is a function taking observations, p_{model} is the probability distribution over the same space indexed by θ, and E_{x˜\tilde{p}}_{data} is the expectation of an empirical distribution of \hat{p}_{data}.

### Mixture Models

A mixture model is a probabilistic model for representing the presence of sub-populations within an overall population of data without requiring that an observed data set identify the sub-population to which an individual observation belongs. Thus, a mixture model corresponds to the mixture distribution that represents the probability distribution of observations in the overall population of observations. Mixture models may be used to make statistical inferences about the properties of the sub-populations given only observations on the pooled population, without sub-population identity information.

Some ways of implementing mixture models involve steps that attribute postulated sub-population identities to individual observations (or weights towards such sub-populations), in which case these can be regarded as types of unsupervised learning or clustering procedures. For example, a Gaussian mixture is a function that comprises several Gaussians, each identified by k∈{1, . . . , K}, where K is a number of clusters in a dataset that share some common characteristics, such as a statistical distribution, a centroid of data points, etc. Each individual Gaussian k in the mixture may comprise the following parameters: a mean μ that defines its center; a covariance Σ that defines its width (equivalent to the dimensions of an ellipsoid in a multivariate scenario); and a mixing probability π that defines a size of the Gaussian function.

A set of parameters regarding each Gaussian may be defined as θ={π,μ,Σ}. Then a maximization algorithm can be applied to determine the optimal values of θ, such as an expectation-maximization (EM) algorithm. For example, the optimal values may be calculated according to:

$${π}_{k} = \frac{{Σ}_{n = 1}^{N} γ ( {z}_{n k} )}{N}$$

$${μ}_{k}^{*} = \frac{{Σ}_{n = 1}^{N} γ ( {z}_{n k} ) {x}_{n}}{{Σ}_{n = 1}^{N} γ ( {z}_{n k} )}$$

$${\sum }_{k}^{*} = \frac{{Σ}_{n = 1}^{N} γ ( {z}_{n k} ) ( {x}_{n} - {μ}_{k} ) {( {x}_{n} - {μ}_{k} )}^{T}}{{Σ}_{n = 1}^{N} γ ( {z}_{n k} )}$$

Notably, this is one example formulation, and others are possible.

### Federated Machine Learning

Conventional machine learning utilizes a centralized data collection and processing architecture. Federated machine learning, by contrast, distributes the machine learning process to multiple devices with their own federated data sets that may not be sharable into a centralized data set. Thus, federate machine learning enables various “edge” processing devices, such as smartphones, to collaboratively learn a shared machine learning model using the training data on individual edge processing devices, but without sharing the individual device data. Rather, the edge processing devices just share resulting model parameters, such as weights and biases, from their own local model optimization procedures. Thus, the data need not be transported over a network to a centralized repository, which reduces data transmission costs while also improving data security and secrecy.

Notably, federated machine learning is becoming extremely compelling because of both the rapidly growing number of edge processing devices with available compute resources, and the growing processing capabilities of such edge processing devices. Even though edge processing devices may be less powerful on a unit-by-unit basis compared to purpose-built machine learning processing systems (e.g., mainframes, servers, supercomputers, etc.), their sheer number can make up for their relatively lesser processing power. Moreover, edge devices, such as smartphones, are increasingly incorporating specialized processing chips, such as neural processors, which are purpose built for performing machine learning processing. Thus, in some instances, an edge device may be more capable than a standard computing device owing to its specialized machine learning hardware.

As described herein, model mixing may be used to combine multiple models (or sub-models or experts) to generate a resultant model.

### Example of Federated Learning Architecture

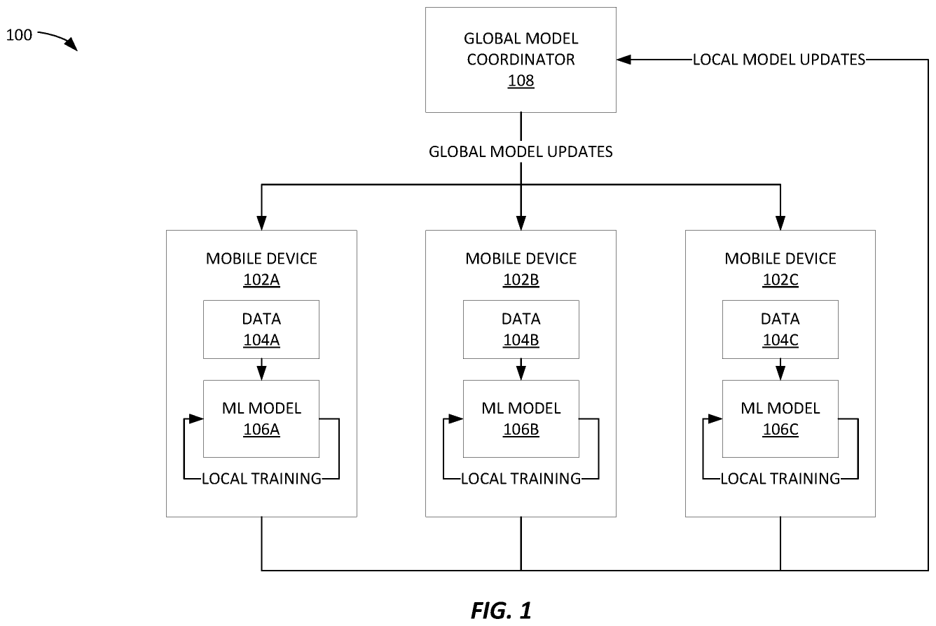

FIG. 1 depicts an example federated learning architecture 100.

In this example, mobile devices 102A-C, which are examples of edge processing devices, each have a local data store 104A-C, respectively, and a local machine learning model instance 106A-C, respectively. For example, mobile device 102A includes an initial machine learning model instance 106A, which it may receive from, for example, global machine learning model coordinator 108, which may be a software provider in some examples. Each of mobile devices 102A-C may use its respective machine learning model instance (106A-C) for some useful task, such as processing local data 104A-C, and further perform local training and optimization of its respective machine learning model instance (106A-C).

For example, mobile device 102A may use its machine learning model 106A for performing facial recognition on pictures stored as data 104A on mobile device 102A. Because these photos may be considered private, mobile device 102A may not want to, or may be prevented from, sharing its photo data with global model coordinator 108. However, mobile device 102A may be willing or permitted to share its local model updates, such as updates to model parameters (e.g., weights and biases), with global model coordinator 108. Similarly, mobile devices 102B and 102C may use their local machine learning model instances, 106B and 106C, respectively, in the same manner and also share their local model updates with global model coordinator 108 without sharing the underlying data (104B and 104C) used to generate the local model updates.

Global model coordinator 108 may use all of the local model updates to determine a global (or consensus) model update, which may then be distributed to mobile devices 102A-C. In this way, federated machine learning may be performed using mobile device 102A-C without centralizing training data and processing.

Thus, federated learning architecture 100 allows for decentralized deployment and training of machine learning models, which may beneficially reduce latency, network use, and power consumption while maintaining data privacy and security and increasing utilization of otherwise idle compute resources. Further, federated learning architecture 100 beneficially allows for local models (e.g., 106A-C) to evolve differently on different devices while simultaneously training a global model based on the local model evolutions.

Notably, the local data stored on mobile devices 102A-C and used by machine learning models 106A-C, respectively, may be referred to as individual data shards (e.g., data 104A-C) and/or federated data. Because these data shards are generated on different devices by different users and are never comingled, they cannot be assumed to be independent and identically distributed (IID) with respect to each other. This is true more generally for any sort of data specific to a device that is not combined for training a machine learning model. Only by combining the individual data sets 104A-C of mobile devices 102A-C, respectively, could a global data set be generated wherein the IID assumption holds.

### Machine Learning With Federated Mixture Models

In order to overcome the non-IID characteristics of federated data used for federated machine learning, such as data 104A-C discussed with respect to FIG. 1, the maximum likelihood optimization method may be extended to be a mixture of K different predictive models, or “experts”. Each expert is expected to model a region in a joint data space (e.g., the data space combining all of the federated data spaces). In order to do so, an assumption may be made that the observed data (e.g., data generated by mobile devices 102A-C in FIG. 1) was created from a mixture of K individual predictive models. Thus, for example, model 106C on mobile device 102A may be considered a single model comprising a plurality of K mixture model components (e.g., experts) in the context of federated mixture model learning. Beneficially, a federated mixture model functions as a single model for providing input to and receiving output from an application using the model.

In one example, the K experts may refer to K different neural network models. In some cases, the neural networks may have the same architecture, while in others they may be different. Let Z be a collection of all z_{s,i}, where there is a z for every data point (y_{s,i},x_{s,i}, Then, z_{s,i} indicates which of the K experts (e.g., neural networks in this example) is chosen to model a particular data point (y_{s,i},x_{s,i}).

Different questions can be asked about the model, such as: given K neural networks, which individual neural network k is “the best” to describe a data point, or how well does each individual neural network k model a given data point (e.g., a posterior can be computed over z_{s,i}). In the methods described herein, determining which expert (e.g., neural network) k is the “best” from the set of K experts is not necessarily the goal. Rather, the goal is to train the K experts (e.g., neural networks) such that each one specializes on a different portion of the global data set.

In a federated training context, data D={(x₁,y₁, . . . , (x_{N}, y_{N}) may be split across S different shards (or sets), such that each shard s owns Nₛ data-points. It can further be assumed that the data across all S shards (e.g., D=D₁ ∪+ . . . ∪D_{S}) is drawn from K clusters, whose parameters w are shared across all shards in each individual cluster.

The total probability of the model then is:

p(Y,Z|X,w)=Πₛ^{s}Πᵢ^{N}^{ₛ}p(y_{s,i}|x_{w,i},w,z_{s,i})p(z_{s,i}) (1)

It may be assumed that the data to be aggregated is in one location to compute the correct gradients for the model. Thus, the data log-likelihood is maximized by computing gradients with respect to w according to:

$${∇}_{w} log p ( Y \vert X , w ) = \vert {∇}_{w} {\sum }_{s}^{S} {\sum }_{i}^{{N}_{s}} log [ {\sum }_{k = 1}^{K} p ( {y}_{s , i} \vert {x}_{s , i} , w , {z}_{s , i} = k ) p ( {z}_{s , i} = k ) ] \qquad ( 2 )$$

$$= {\sum }_{s}^{S} {\sum }_{i}^{{N}_{s}} \frac{{Σ}_{k = 1}^{K} {∇}_{w} p ( {y}_{s , i} \vert {x}_{s , i} , w , {z}_{s , i} = k ) p ( {z}_{s , i} = k )}{{Σ}_{{k}^{′} = 1}^{K} p ( {y}_{s , i} \vert {x}_{s , i} , w , {z}_{s , i} = {k}^{′} ) p ( {z}_{s , i} = {k}^{′} )} \qquad ( 3 )$$

$$= {\sum }_{s}^{S} {\sum }_{i}^{{N}_{s}} {\sum }_{k = 1}^{K} \frac{p ( {y}_{s , i} \vert {x}_{s , i} , w , {z}_{s , i} = k ) p ( {z}_{s , i} = k )}{{Σ}_{{k}^{′} = 1}^{K} p ( {y}_{s , i} \vert {x}_{s , i} , w , {z}_{s , i} = {k}^{′} ) p ( {z}_{s , i} = {k}^{′} )} {∇}_{w} log p ( {y}_{s , i} \vert {x}_{s , i} , w , {z}_{s , i} = k ) \qquad ( 4 )$$

$$= {\sum }_{s}^{S} [ {\sum }_{i}^{{N}_{s}} {\sum }_{k = 1}^{K} p ( {z}_{i , s} = k \vert {y}_{i , s} {x}_{i , s} , w ) \cdot {∇}_{w} log p ( {y}_{s , i} \vert {x}_{s , i} , w , {z}_{s , i} = k ) ] \qquad ( 5 )$$

In a federated learning scenario, a global server (e.g., global model coordinator 108 in FIG. 1) sends to each local worker (e.g., mobile devices 102A-C in FIG. 1) a copy of the current parameters w. Each worker s is tasked to compute one part of the total gradient (within outer brackets in Equation (5)) corresponding to their Nₛ data-points. Instead of just performing one gradient update per local worker, the local workers perform several gradient updates on their local copy of the parameters, which allows progress locally without relying on frequent, slow, and potentially costly data communication.

In some cases, averaging the updates from the local workers based on each local worker's repeated determination of the gradients according to Equation (5) does not perform optimally. This is due to the fact that it is beneficial to use adaptive learning rate optimization algorithms, such as Adam (which has been designed for training deep neural networks), to speed up learning progress on each local shard. Since each local worker maintains individual Adam momenta, naively averaging the resulting updates does not correctly take into account the influence of each shard on a particular expert k (of the set K) compared to the other shards.

A technical solution to this technical model optimization problem is to further develop equation (5). For notational convenience, the focus may be on the gradient with respect to one mixture component wₖ only and a “soft” count Nₛₖ may be defined according to:

Nₛₖ=Σᵢ^{N}^{ₛ}p(z_{i,s}=k|y_{i,s},x_{i,s},w) (6)

Equation (6) thus allows Equation (5) to be extended as follows:

$${∇}_{w k} log p ( Y \vert X , w ) \qquad ( 7 )$$

$$= {\sum }_{s}^{S} {N}_{s k} {\sum }_{i}^{{N}_{s}} \frac{( {z}_{i , s} = k \vert {y}_{i , s} , {x}_{i , s} , w )}{{N}_{s k}} {∇}_{w} log p ( {y}_{s , i} \vert {x}_{s , i} , w , {z}_{s , i} = k ) \qquad ( 8 )$$

$$\approx {\sum }_{s}^{S} \frac{{N}_{s k}}{{N}_{s}} {\sum }_{i}^{{N}_{s}} \frac{/ {N}_{s} p ( {z}_{i , s} = k \vert {y}_{i , s} , {x}_{i , s} , w )}{\frac{/ {N}_{s}}{M} {Σ}_{j}^{M} p ( {z}_{j , s} = k \vert {y}_{j , s} , {x}_{j , s} , w )} {∇}_{w} log p ( {y}_{s , i} \vert {x}_{s , i} , w , {z}_{s , i} = k ) \qquad ( 9 )$$

$$\approx {\sum }_{s}^{S} \frac{{N}_{s k}}{{N}_{s}} \frac{{N}_{s}}{M} {\sum }_{i}^{M} \frac{p ( {z}_{i , s} = k \vert {y}_{i , s} , {x}_{i , s} , w )}{\frac{1}{M} {Σ}_{j}^{M} p ( {z}_{j , s} = k \vert {y}_{j , s} , {x}_{j , s} , w )} {∇}_{w} log p ( {y}_{s , i} \vert {x}_{s , i} , w , {z}_{s , i} = k ) \qquad ( 10 )$$

$$= {\sum }_{s}^{S} {N}_{s k} [ \frac{1}{M} {\sum }_{i}^{M} \frac{p ( {z}_{i , s} = k \vert {y}_{i , s} , {x}_{i , s} , w )}{\frac{1}{M} {Σ}_{j}^{M} p ( {z}_{j , s} = k \vert {y}_{j , s} , {x}_{j , s} , w )} {∇}_{w} log p ( {y}_{s , i} \vert {x}_{s , i} , w , {z}_{s , i} = k ) ] \qquad ( 11 )$$

In Equation (11), the local workers compute and apply the gradient within the outer brackets for τ steps. After τ local updates to w_{s,k}^{t}, which results in w_{s,k}^{t+τ}, each local worker sends to the global server an updated set of parameters w_{s,k}^{t+τ}. The global server then interprets these updated parameters by computing the “effective gradient” as the change towards the current global server parameters. For example:

wₖ^{t+1}←wₖ^{t}−αΣₛ^{s}Nₛₖ·(wₖ^{t}−w_{s,k}^{t+τ}) (12)

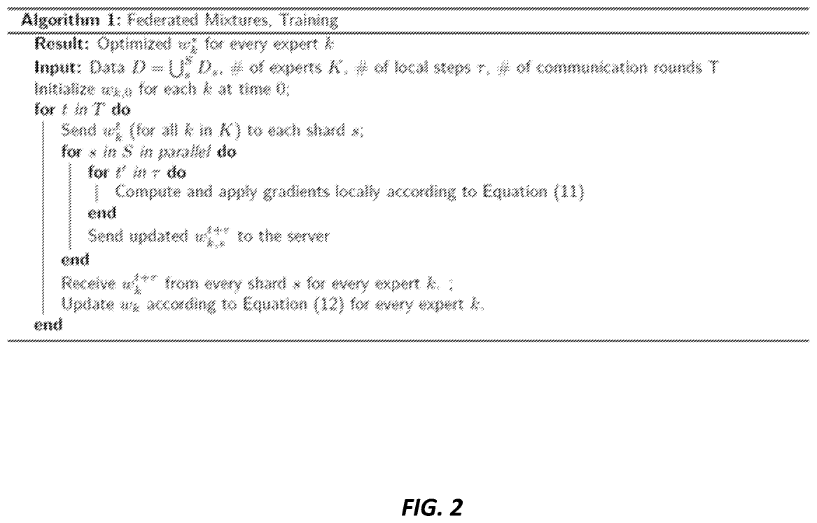

FIG. 2 depicts an example of a federated mixture algorithm based on the above derived equations.

Note that the algorithm in FIG. 2 in an example of a distributed synchronized training algorithm, and there can be variations to this algorithm. For example, the algorithm may be varied for an asynchronous training context.

### Generating More Expressive Priors

The formulation for Equation (1) may be further extended to allow for a more expressive prior p(z_{s,i}) over which an expert k is to be selected for a data point (y_{s,i}, x_{s,i}). Here, the subscripts s and i enumerate shards and data points within a shard respectively, as described with respect to Equation (1). Intuitively, an expert k should be selected from all K experts that is best suited to perform the classification (or regression) task for a particular machine learning model. In one embodiment, the decision about how much weight should be put on the prediction of an expert k can be made by looking at the input x_{s,i} instead of, for example, assigning equal probability to each expert k in set K.

In order to determine p(z=k|x) based on a data point x, the mapping needs to be parameterized and learned. In one embodiment, this may be accomplished by interpreting p(z=k|x) as the responsibilities of an (unsupervised) clustering problem, for example, according to:

$$p ( z = k \vert x ) = \frac{p ( x \vert {ϕ}_{k} ) p ( z = k )}{{Σ}_{{k}^{′}} p ( x \vert {ϕ}_{{k}^{′}} ) p ( z = {k}^{′} )} \qquad ( 13 )$$

Thus, each cluster is parameterized by ϕₖ, where there is a one-to-one correspondence between a cluster k and an expert k, where k′ represents an index for the summation. The parameters ϕₖ are jointly optimized with wₖ as part of the same algorithmic formulation. In the same manner as described for wₖ in Algorithm 1, the parameters ϕₖ are trained by performing local updates using local data and periodically sent to (e.g., synchronized with) the global server (e.g., global model coordinator 108 in FIG. 1).

### Example Method of Processing Federated Mixture Model Data on an Edge Device

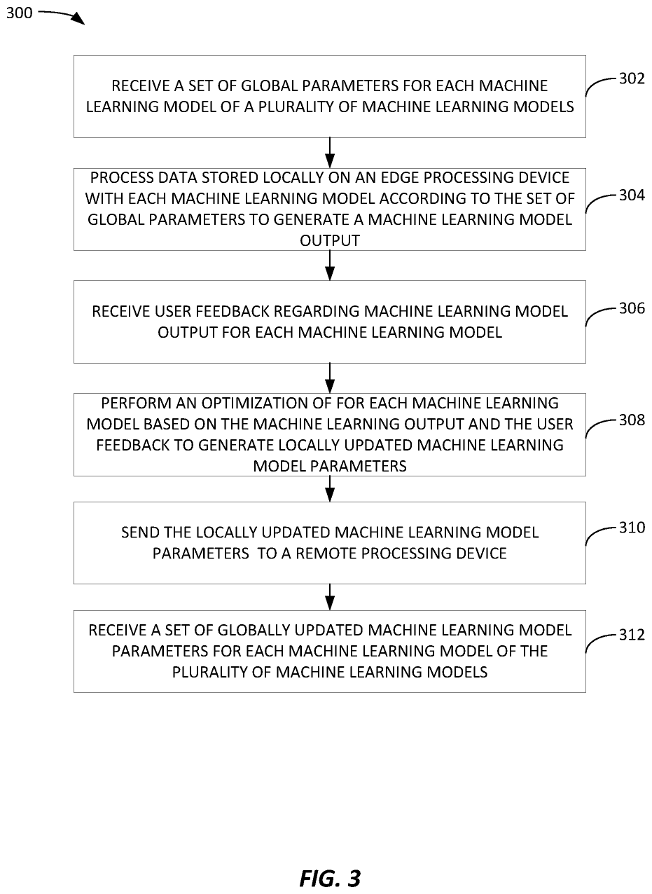

FIG. 3 depicts an example method 300 of processing federated mixture model data on an edge device, such as, for example, mobile device 102A-C in FIG. 1.

Method 300 begins at step 302 with receiving, at an edge processing device s, a set of global parameters wₖ^{t} for each machine learning model k of a plurality of machine learning models K.

Method 300 the proceeds to step 304 with, for each respective machine learning model k of the plurality of machine learning models K: processing, at the edge processing device, data stored locally on the edge processing device with respective machine learning model k according to the set of global parameters wₖ^{t} to generate a machine learning model output y_{s,k}.

Method 300 the proceeds to step 306 with, for each respective machine learning model k of the plurality of machine learning models K: receiving, at the edge processing device, user feedback regarding machine learning model output y_{s,k}.

Method 300 then proceeds to step 308 with, for each respective machine learning model k of the plurality of machine learning models K: performing, at the edge processing device, an optimization of the respective machine learning model k based on the machine learning output y_{s,k} and the user feedback associated with machine learning model output y_{s,k} to generate locally updated machine learning model parameters w_{s,k}^{t+τ}. Note that in some embodiments, the optimization depend on all other model outputs y_{s,k}* for all other models k* in addition to y_{s,k} for model k.

Method 300 the proceeds to step 310 with, for each respective machine learning model k of the plurality of machine learning models K: sending the locally updated machine learning model parameters w_{s,k}^{T+τ} to a remote processing device.

Method 300 the proceeds to step 312 with receiving, from the remote processing device, a set of globally updated machine learning model parameters wₖ^{t+τ} for each machine learning model k of the plurality of machine learning models K.

In some embodiments of method 300, the globally updated machine learning model parameters wₖ^{t+τ} for each respective machine learning model k are based at least in part on the locally updated machine learning model parameters w_{s,k}^{t+τ}.

Some embodiments of method 300 further include: performing at the edge processing device, a number of optimizations τ before sending the locally updated machine learning model parameters w_{s,k}^{t+τ} to the remote processing device.

In some embodiments of method 300, the globally updated machine learning model parameters wₖ^{t+τ} for each respective machine learning model k of the plurality of machine learning models K are based at least in part on locally updated machine learning model parameters of a second edge processing device.

In some embodiments of method 300, the user feedback comprises an indication of the correctness of the machine learning model output.

In some embodiments of method 300, the data stored locally on the edge processing device is one of: image data, audio data, or video data.

In some embodiments of method 300, the edge processing device is one of a smartphone or an internet of things device.

### Example Method of Processing Federated Mixture Model Data on a Server Device

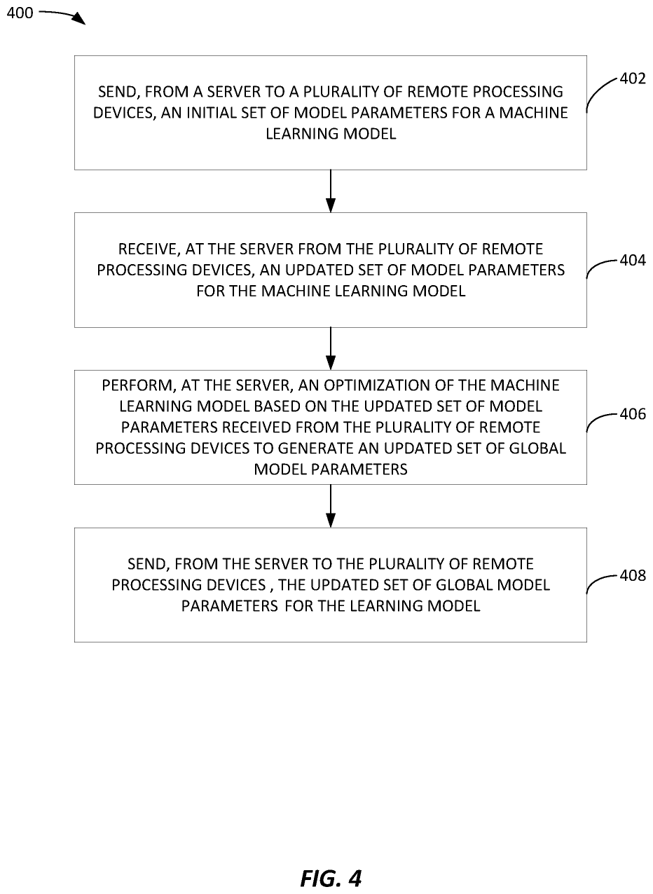

FIG. 4 depicts an example method 400 of processing federated mixture model data on a centralized device, such as a server device (e.g., global model coordinator 108 in FIG. 1).

Method 400 begins at step 402 with sending, from a server to a respective remote processing device s, an initial set of model parameters wₖ^{t} for a respective machine learning model k.

Method 400 then proceeds to step 404 with receiving, at the server from the respective remote processing device s, an updated set of model parameters w_{s,k}^{t+τ} for the respective machine learning model k.

Method 400 then proceeds to step 406 with performing, at the server, an optimization of the respective machine learning model k based on the updated set of model parameters w_{s,k}^{t+τ} received from each remote processing device s of the plurality of remote processing devices S to generate an updated set of global model parameters wₖ^{t+τ}.

Note that in some embodiments, steps 402-406 may be iteratively performed for each respective model k of a plurality of models K and for each respective remote processing device s of a plurality of remote processing devices S.

Method 400 then proceeds to step 408 with sending, from the server to each remote processing device s of the plurality of remote processing devices S, the updated set of global model parameters wₖ^{t+τ} for each machine learning model k of the plurality of models K.

In some embodiments of method 400, performing, at the server, an optimization of the respective machine learning model k comprises computing an effective gradient according to: wₖ^{t+1}←wₖ^{t}−αΣₛ^{s}Nₛₖ·(wₖ^{t}−w_{s,k}^{t+T}).

Some embodiments of method 400 further include: for each respective model k of the plurality of models K: determining a corresponding density estimator p(x|ϕₖ) parameterized by weighting parameters ϕₖ for the respective model k. The weighting parameters ϕₖ may be used to combine the k models (or sub-models) into a single model output based on a model input. In this way, multiple models (e.g., K models) can be trained and “mixed” via weighting parameters ϕₖ.

Some embodiments of method 400 further include: determining prior mixture weights for the respective model k according to:

$$p ( z = k \vert x ) = \frac{p ( x \vert {ϕ}_{k} ) p ( z = k )}{{Σ}_{{k}^{′}} p ( x \vert {ϕ}_{{k}^{′}} ) p ( z = {k}^{′} )} .$$

In some embodiments of method 400, the remote processing device is a smartphone.

In some embodiments of method 400, the remote processing device an internet of things device.

In some embodiments of method 400, each respective model k of the plurality of models K is a neural network model. In some embodiments of method 400, wherein each respective model k of the plurality of models K comprises a same network structure. In some embodiments of method 400, one or more of the plurality of models K comprises a different network structure than the other models in the plurality of models K.

### Example Processing System

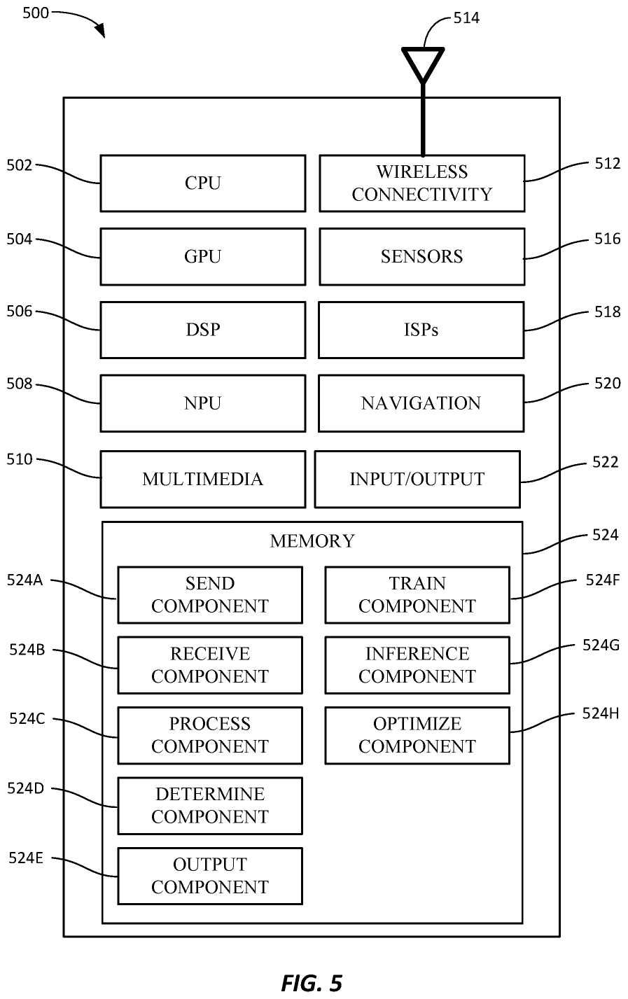

FIG. 5 illustrates an example electronic device 500. Electronic device 500 may be configured to perform the methods described herein, including with respect to FIGS. 3 and 4.

Electronic device 500 includes a central processing unit (CPU) 502, which in some embodiments may be a multi-core CPU. Instructions executed at the CPU 502 may be loaded, for example, from a program memory associated with the CPU 502 or may be loaded from a memory block 524.

Electronic device 500 also includes additional processing blocks tailored to specific functions, such as a graphics processing unit (GPU) 504, a digital signal processor (DSP) 506, a neural processing unit (NPU) 508, a multimedia processing block 510, a multimedia processing unit 510, and a wireless connectivity block 512.

An NPU, such as 508, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as tensor processing units (TPU), neural network processor (NNP), intelligence processing unit (IPU), vision processing unit (VPU), or graph processing unit.

NPUs, such as 508, may be configured to accelerate the performance of common machine learning tasks, such as image classification, machine translation, object detection, and various other predictive models. In some embodiments, a plurality of NPUs may be instantiated on a single chip, such as a system on a chip (SoC), while in other embodiments they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training may be generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 508 is a part of one or more of CPU 502, GPU 504, and/or DSP 506.

In some embodiments, wireless connectivity block 512 may include components, for example, for third generation (3G) connectivity, fourth generation (4G) connectivity (e.g., 4G LTE), fifth generation connectivity (e.g., 5G or NR), Wi-Fi connectivity, Bluetooth connectivity, and wireless data transmission standards. Wireless connectivity processing block 512 is further connected to one or more antennas 514.

Electronic device 500 may also include one or more sensor processors 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

Electronic device 500 may also include one or more input and/or output devices 522, such as screens, touch-sensitive surfaces (including touch-sensitive displays), physical buttons, speakers, microphones, and the like.

In some embodiments, one or more of the processors of electronic device 500 may be based on an ARM or RISC-V instruction set.

Electronic device 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of electronic device 500. In particular, in this embodiment, memory 524 includes send component 524A, receive component 524B, process component 524C, determine component 524D, output component 524E, train component 524F, inference component 524G, and optimize component 524H. The depicted components, and others not depicted, may be configured to perform various aspects of the methods described herein.

Generally, electronic device 500 and/or components thereof may be configured to perform the methods described herein.

Notably, in other embodiments, aspects of electronic device 500 may be omitted, such as where electronic device 500 is a server computer or the like. For example, multimedia component 510, wireless connectivity 512, sensors 516, ISPs 518, and/or navigation component 520 may be omitted in other embodiments. Further, aspects of electronic device 500 may be distributed, such as in cloud-based processing environments.

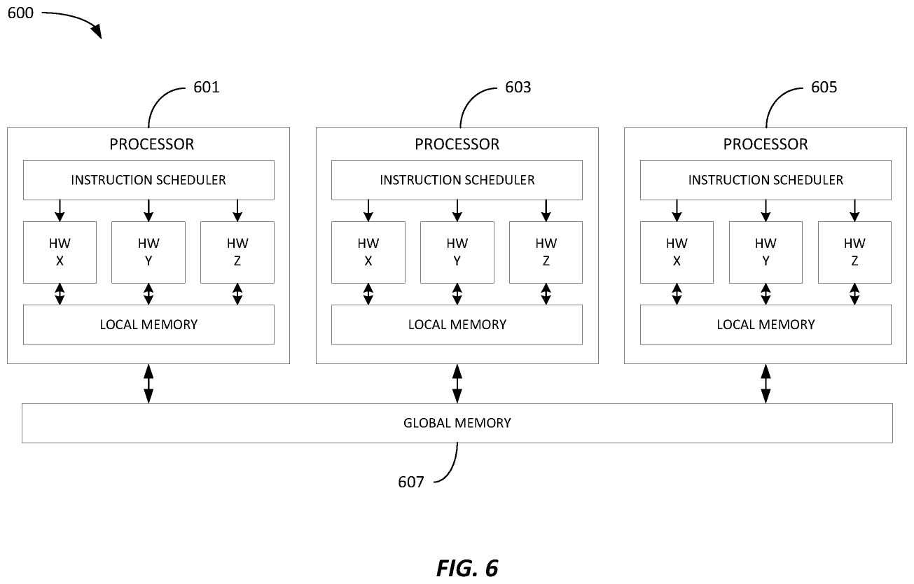

FIG. 6 depicts an example multi-processor processing system 600 that may be implemented with embodiments described herein. For example, multi-processing system 600 may be representative of various processors of electronic device 500 of FIG. 5.

In this example, system 600 includes processors 601, 603, and 605, but in other examples, any number of individual processors may be used. Further, though depicted similarly, processors 601, 603, and 605 may be representative of various different kinds of processors in an electronic device, such as CPUs, GPUs, DSPs, NPUs, and the like as described herein.

Each of processors 601, 603, and 605 includes an instruction scheduler, various hardware sub-components (e.g., hardware X, hardware Y, and hardware Z), and a local memory. In some embodiments, the local memory may be a tightly coupled memory (TCM). Note that while the components of each of processors 601, 603, and 605 are shown as the same in this example, in other examples, some or each of the processors 601, 603, and 605 may have different hardware configurations, different hardware elements, etc.

Each of processors 601, 603, and 605 is also in data communication with a global memory, such as a DDR memory, or other types of volatile working memory. For example, global memory 607 may be representative of memory 524 of FIG. 5.

In some implementations, in a multi-processor processing system such as 600, one of the processors may act as a master processor. For example, processor 601 may be a master processor in this example. A master processor may include a compiler that, when executed, can determine how a model, such as a neural network, will be processed by various components of processing system 600. For example, hardware parallelism may be implemented by mapping portions of the processing of a model to various hardware (e.g., hardware X, hardware Y, and hardware Z) within a given processor (e.g., processor 601) as well as mapping portions of the processing of the model to other processors (e.g., processors 603 and 605) and their associated hardware. For example, the parallel blocks in the parallel block processing architectures described herein may be mapped to different portions of the various hardware in processors 601, 603, and 605.

### Example Clauses

Clause 1: A method of processing data, comprising: receiving, at an processing device, a set of global parameters for each machine learning model of a plurality of machine learning models; for each respective machine learning model of the plurality of machine learning models: processing, at the processing device, data stored locally on the processing device with respective machine learning model according to the set of global parameters to generate a machine learning model output; receiving, at the processing device, user feedback regarding the machine learning model output; performing, at the processing device, an optimization of the respective machine learning model based on the machine learning model output and the user feedback associated with machine learning model output to generate locally updated machine learning model parameters; and sending the locally updated machine learning model parameters to a remote processing device; and receiving, from the remote processing device, a set of globally updated machine learning model parameters for each machine learning model of the plurality of machine learning models, wherein the set of globally updated machine learning model parameters for each respective machine learning model are based at least in part on the locally updated machine learning model parameters.

Clause 2: The method of Clause 1, further comprising performing at the processing device, a number of optimizations before sending the locally updated machine learning model parameters to the remote processing device.

Clause 3: The method of any one of Clauses 1-2, wherein the set of globally updated machine learning model parameters for each respective machine learning model of the plurality of machine learning models are based at least in part on locally updated machine learning model parameters of a second processing device.

Clause 4: The method of any one of Clauses 1-3, wherein the user feedback comprises an indication of a correctness of the machine learning model output.

Clause 5: The method of any one of Clauses 1-4, wherein the data stored locally on the processing device is one of: image data, audio data, or video data.

Clause 6: The method of any one of Clauses 1-5, wherein the processing device is one of a smartphone or an internet of things device.

Clause 7: The method of any one of Clauses 1-6, wherein processing, at the processing device, the data stored locally on the processing device with the machine learning model is performed at least in part by one or more neural processing units.

Clause 8: The method of any one of Clauses 1-7, wherein performing, at the processing device, the optimization of the machine learning model is performed at least in part by one or more neural processing units.

Clause 9: A method of processing data, comprising: for each respective machine learning model of a plurality of machine learning models: for each respective remote processing device of a plurality of remote processing devices: sending, from a server to the respective remote processing device, an initial set of global model parameters for the respective machine learning model; and receiving, at the server from the respective remote processing device, an updated set of model parameters for the respective machine learning model; and performing, at the server, an optimization of the respective machine learning model based on the updated set of model parameters received from each remote processing device of the plurality of remote processing devices to generate an updated set of global model parameters; and sending, from the server to each remote processing device of the plurality of remote processing devices, the updated set of global model parameters for each machine learning model of the plurality of machine learning models.

Clause 10: The method of Clause 9, wherein performing, at the server, an optimization of the respective machine learning model comprises computing an effective gradient for each model parameter of the initial set of global model parameters for the respective machine learning model.

Clause 11: The method of any one of Clauses 9-10, further comprising, for each respective machine learning model of the plurality of machine learning models, determining a corresponding density estimator parameterized by weighting parameters for the respective machine learning model.

Clause 12: The method of Clause 11, further comprising determining prior mixture weights for the respective machine learning model.

Clause 13: The method of any one of Clauses 9-12, wherein the plurality of remote processing devices comprises a smartphone.

Clause 14: The method of any one of Clauses 9-13, wherein the plurality of remote processing devices comprise an internet of things device.

Clause 15: The method of any one of Clauses 9-14, wherein each respective machine learning model of the plurality of machine learning models is a neural network model.

Clause 16: The method of Clause 15, wherein each respective machine learning model of the plurality of machine learning models comprises a same network structure.

Clause 17: A processing system, comprising: a memory comprising computer-executable instructions; one or more processors configured to execute the computer-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium comprising computer-executable instructions that, when executed by one or more processors of a processing system, cause the processing system to perform a method in accordance with any one of Clauses 1-16.

Clause 20: A computer program product embodied on a computer-readable storage medium comprising code for performing a method in accordance with any one of Clauses 1-16.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of processing data, comprising:
receiving, at an processing device, a set of global parameters for each machine learning model of a plurality of machine learning models;
for each respective machine learning model of the plurality of machine learning models:
processing, at the processing device, data stored locally on the processing device with respective machine learning model according to the set of global parameters to generate a machine learning model output;
receiving, at the processing device, user feedback regarding the machine learning model output;
performing, at the processing device, an optimization of the respective machine learning model based on the machine learning model output and the user feedback associated with machine learning model output to generate locally updated machine learning model parameters; and
sending the locally updated machine learning model parameters to a remote processing device; and
receiving, from the remote processing device, a set of globally updated machine learning model parameters for each machine learning model of the plurality of machine learning models,
wherein the set of globally updated machine learning model parameters for each respective machine learning model are based at least in part on the locally updated machine learning model parameters.

2. The method of claim 1, further comprising performing at the processing device, a number of optimizations before sending the locally updated machine learning model parameters to the remote processing device.

3. The method of claim 1, wherein the set of globally updated machine learning model parameters for each respective machine learning model of the plurality of machine learning models are based at least in part on locally updated machine learning model parameters of a second processing device.

4. The method of claim 1, wherein the user feedback comprises an indication of a correctness of the machine learning model output.

5. The method of claim 1, wherein the data stored locally on the processing device is one of: image data, audio data, or video data.

6. The method of claim 1, wherein the processing device is one of a smartphone or an internet of things device.

7. The method of claim 1, wherein processing, at the processing device, the data stored locally on the processing device with the machine learning model is performed at least in part by one or more neural processing units.

8. The method of claim 1, wherein performing, at the processing device, the optimization of the machine learning model is performed at least in part by one or more neural processing units.

9. A processing device, comprising:
a memory comprising computer-executable instructions;
one or more processors configured to execute the computer-executable instructions and cause the processing device to:
receive a set of global parameters for each machine learning model of a plurality of machine learning models;
for each respective machine learning model of the plurality of machine learning models:
process data stored locally on processing device with respective machine learning model according to the set of global parameters to generate a machine learning model output;
receive user feedback regarding machine learning model output;
perform an optimization of the respective machine learning model based on the machine learning model output and the user feedback associated with machine learning model output to generate locally updated machine learning model parameters; and
send the locally updated machine learning model parameters to a remote processing device; and
receive, from the remote processing device, a set of globally updated machine learning model parameters for each machine learning model of the plurality of machine learning models,
wherein the set of globally updated machine learning model parameters for each respective machine learning model are based at least in part on the locally updated machine learning model parameters.

10. The processing device of claim 9, wherein the one or more processors are further configured to cause the processing device to perform a number of optimizations before sending the locally updated machine learning model parameters to the remote processing device.

11. The processing device of claim 9, wherein the set of globally updated machine learning model parameters for each respective machine learning model of the plurality of machine learning models are based at least in part on locally updated machine learning model parameters of a second processing device.

12. The processing device of claim 9, wherein the user feedback comprises an indication of a correctness of the machine learning model output.

13. The processing device of claim 9, wherein the processing device is one of a smartphone or an internet of things device.

14. The processing device of claim 9, wherein one of the one or more processors is a neural processing unit configured to process the data stored locally on the processing device with the machine learning model.

15. The processing device of claim 9, wherein one of the one or more processors is a neural processing unit configured to perform the optimization of the machine learning model.

16. A method of processing data, comprising:
for each respective machine learning model of a plurality of machine learning models:
for each respective remote processing device of a plurality of remote processing devices:
sending, from a server to the respective remote processing device, an initial set of global model parameters for the respective machine learning model; and
receiving, at the server from the respective remote processing device, an updated set of model parameters for the respective machine learning model; and
performing, at the server, an optimization of the respective machine learning model based on the updated set of model parameters received from each remote processing device of the plurality of remote processing devices to generate an updated set of global model parameters; and
sending, from the server to each remote processing device of the plurality of remote processing devices, the updated set of global model parameters for each machine learning model of the plurality of machine learning models.

17. The method of claim 16, wherein performing, at the server, an optimization of the respective machine learning model comprises computing an effective gradient for each model parameter of the initial set of global model parameters for the respective machine learning model.

18. The method of claim 16, further comprising, for each respective machine learning model of the plurality of machine learning models, determining a corresponding density estimator parameterized by weighting parameters for the respective machine learning model.

19. The method of claim 18, further comprising determining prior mixture weights for the respective machine learning model.

20. The method of claim 16, wherein the plurality of remote processing devices comprises a smartphone.

21. The method of claim 16, wherein the plurality of remote processing devices comprise an internet of things device.

22. The method of claim 16, wherein each respective machine learning model of the plurality of machine learning models is a neural network model.

23. The method of claim 22, wherein each respective machine learning model of the plurality of machine learning models comprises a same network structure.

24. A processing device, comprising:
a memory comprising computer-executable instructions;
one or more processors configured to execute the computer-executable instructions and cause the processing device to:
for each respective machine learning model of a plurality of machine learning models:
for each respective remote processing device of a plurality of remote processing devices:
send to the respective remote processing device, an initial set of global model parameters for the respective machine learning model; and
receive from the respective remote processing device, an updated set of model parameters for the respective machine learning model; and
perform an optimization of the respective machine learning model based on the updated set of model parameters received from each remote processing device of the plurality of remote processing devices to generate an updated set of global model parameters; and
send to each remote processing device of the plurality of remote processing devices the updated set of global model parameters for each machine learning model of the plurality of machine learning models.

25. The processing device of claim 24, wherein in order to perform the optimization of the respective machine learning model, the one or more processors are further configured to cause the processing device to compute an effective gradient for each model parameter of the initial set of global model parameters for the respective machine learning model.

26. The processing device of claim 24, wherein the one or more processors are further configured to cause the processing device to, for each respective machine learning model of the plurality of machine learning models, determine a corresponding density estimator parameterized by weighting parameters for the respective machine learning model.

27. The processing device of claim 26, wherein the one or more processors are further configured to cause the processing device to, for each respective machine learning model of the plurality of machine learning models, determine prior mixture weights for the respective machine learning model.

28. The processing device of claim 24, wherein the plurality of remote processing devices comprises a smartphone.

29. The processing device of claim 24, wherein each respective machine learning model of the plurality of machine learning models is a neural network model.

30. The processing device of claim 29, wherein each respective machine learning model of the plurality of machine learning models comprises a same network structure.
